(19) United States
(12) Patent Application Publication
(10) Pub. No.: US 2022/0342964 A1
(43) Pub. Date: Oct. 27, 2022

(54) ELEMENT ADDITION METHOD AND INFORMATION PROCESSING APPARATUS

(71) Applicant: FUJITSU LIMITED, Kawasaki-shi (JP)

(72) Inventor: Satoshi Munakata, Kawasaki (JP)

(73) Assignee: FUJITSU LIMITED, Kawasaki-shi (JP)

(21) Appl. No.: 17/584,802

(22) Filed: Jan. 26, 2022

(30) Foreign Application Priority Data
Apr. 23, 2021 (JP) 2021-073036

(51) Int. Cl. G06F 21/31

(52) U.S. Cl. CPC G06F 21/31

(57) ABSTRACT

A non-transitory computer-readable recording medium stores an element addition program that causes a computer to execute a process, the process includes generating a prefix pattern and a suffix pattern based on an element that is added to a binary decision diagram, in response to registration of the element, and adding the prefix pattern and the suffix pattern to the binary decision diagram while distributing the prefix pattern and the suffix pattern respectively to two regions on a root side and a terminal side of the binary decision diagram.

### CROSS-REFERENCE TO RELATED APPLICATION

This application is based upon and claims the benefit of priority of the prior Japanese Patent Application No. 2021-73036, filed on Apr. 23, 2021, the entire contents of which are incorporated herein by reference.

### FIELD

The embodiment discussed herein is related to an element addition method and an information processing apparatus.

### BACKGROUND

A combination set is a set including combinations of items in a certain item set. Generally, the number of combinations included in the combination set (the number of combinations corresponding to elements in the combination set) is larger than the number of original items in many cases. Thus, it is often difficult to explicitly hold all of the contents of the combination set. Accordingly, there has been proposed an expression form that compactly expresses the combination set and that enables efficient execution of operations such as an inquiry (hereinafter referred to as a query) for the combination set and merging of the combination set with another combination set. Such an expression form is widely used in fields such as, for example, frequent pattern mining of purchase data, document summarization, analysis related to a communication network, and mathematical optimization.

The aforementioned expression form is also referred to as decision diagram and a binary decision diagram (BDD) is known as one of the decision diagrams. Since the BDD expresses the combination set in a compressed manner and may be used to answer various queries, the BDD is widely used. A zero-suppressed binary decision diagram (ZDD) is known as one type of BDD. Since the ZDD is capable of expressing a sparse combination set, which often appears in real life, in a highly-compressed manner, the ZDD is actually used in many cases. The sparse combination set is, for example, a combination set that includes, among combinations corresponding to elements of the combination set, many combinations formed of few items. The sparse combination set may be a combination set such as a combination set in which the number of elements of the combination set is significantly smaller than the total number of combinations but is significantly larger than the number of original items.

Japanese Laid-open Patent Publication No. 2020-201556, U.S. Patent Application Publication No. 2008/0270337, and S. Minato, “Zero-Suppressed BDDs for Set Manipulation in Combinatorial Problems”, 1993, 30th ACM/IEEE Design Automation Conference are disclosed as related art.

### SUMMARY

According to an aspect of the embodiment, a non-transitory computer-readable recording medium stores an element addition program that causes a computer to execute a process, the process includes generating a prefix pattern and a suffix pattern based on an element that is added to a binary decision diagram, in response to registration of the element, and adding the prefix pattern and the suffix pattern to the binary decision diagram while distributing the prefix pattern and the suffix pattern respectively to two regions on a root side and a terminal side of the binary decision diagram.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a hardware configuration of a data processing apparatus;

FIG. 2 is a block diagram illustrating a functional configuration of the data processing apparatus;

FIG. 3 is a flowchart illustrating a process executed by the data processing apparatus;

FIG. 4A is an example of a node table before and after initialization;

FIG. 4B is an example of a ZDD corresponding to the node table before the initialization;

FIG. 5 is an example of a combination table before and after the initialization;

FIG. 6 is an example of the combination table before and after element registration;

FIG. 7 is an example of the combination table before and after a pattern generation process;

FIG. 8 is an example of the combination table and the node table before and after a pattern addition process;

FIG. 9 is another example of the combination table before and after the element registration;

FIG. 10 is another example of the combination table before and after the pattern generation process;

FIG. 11 is another example of the combination table and the node table before and after the pattern addition process;

FIG. 12 is examples of ZDDs according to the embodiment;

FIG. 13 is examples of ZDDs according to a comparative example;

FIG. 14 is an example of a table for explaining an effect of reducing the number of nodes;

FIG. 15 is an example of a flowchart of the pattern generation process; and

FIG. 16 is an example of a flowchart of the pattern addition process.

### DESCRIPTION OF EMBODIMENT

Assume a method of dynamically generating an authorization policy that controls access to a computer system by using the aforementioned binary decision diagram. For example, when the authorization policy for access permission is to be generated, it is assumed that a permission pattern is determined based on information in an actual log of past access permission, and the permission pattern is extracted as an authorization policy in a table format. When there is access from someone to a some kind of subject, this access may be thereby permitted as long as the access satisfies the authorization policy.

In the case where the permission pattern is determined, a wild card may be used for common items for which access may be permitted. The wild card is an alternative character expressing arbitrary character (or arbitrary character string). For example, when an authorization policy that allows access to any data if the subject of access is Taro is to be generated, the authorization policy may be generated by registering Taro as the subject of access in the authorization policy and registering the wild card as the object of access. Taro may thereby access any data. Meanwhile, when the subject of access is Hana, Hana is unable to access any data, if only Taro is registered in the authorization policy. Using the wild card as described above allows the size of the authorization policy to be reduced from that in the case where various pieces of data are individually registered for the authorization policy. As a result, the usage of memory used by the authorization policy may be suppressed.

However, the usage of memory becomes tight with an increase in the number of permission patterns even if the authorization policy is dynamically generated by using the wild card. In such a case, it is possible to compress the permission pattern and suppress the usage of memory by expressing the permission pattern with the binary decision diagram. For example, when the subject of access and the object of access are added as elements in the binary decision diagram, the usage of memory may be reduced from that in the case where the binary decision diagram is not used. However, when the elements are added to the binary decision diagram, redundant elements excessively appear in the binary decision diagram depending on the order of addition, and the usage of memory is not sufficiently reduced in some cases.

An embodiment of the present disclosure will be described below with reference to the drawings.

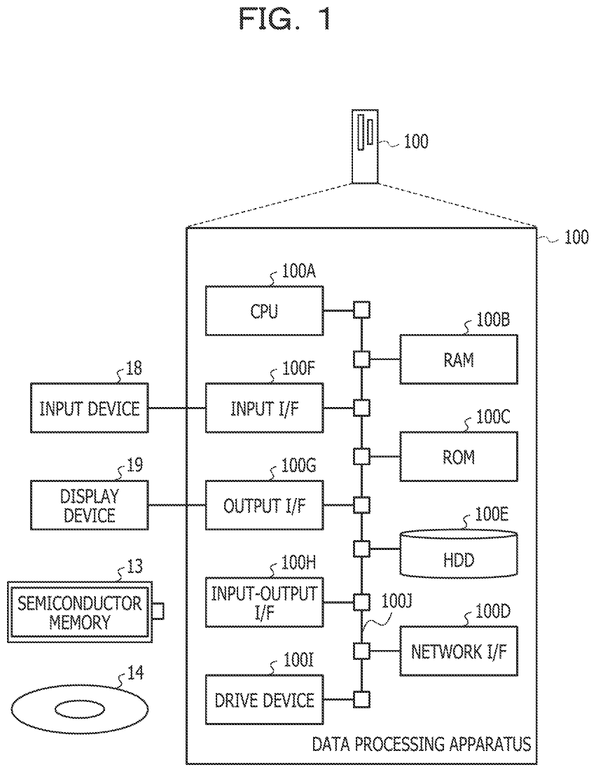

First, a hardware configuration of a data processing apparatus 100 that executes an element addition method will be described with reference to FIG. 1. As illustrated in FIG. 1, the data processing apparatus 100 includes a central processing unit (CPU) 100A as a processor and a random-access memory (RAM) 100B and a read-only memory (ROM) 100C as memories. The data processing apparatus 100 includes a network interface (I/F) 100D and a hard disk drive (HDD) 100E. A solid-state drive (SSD) may be used instead of the HDD 100E.

The data processing apparatus 100 may include at least one of an input I/F 100F, an output I/F 100G, an input-output I/F 100H, and a drive device 100I as appropriate. The components from the CPU 100A to the drive device 100I are coupled to one another via an internal bus 100J. For example, the data processing apparatus 100 may be implemented by a computer (information processing apparatus).

An input device 18 is coupled to the input I/F 100F. Examples of the input device 18 include a keyboard, a mouse, a touch panel, and the like. A display device 19 is coupled to the output I/F 100G. Examples of the display device 19 include a liquid crystal display and the like. A semiconductor memory 13 is coupled to the input-output I/F 100H. Examples of the semiconductor memory 13 include a Universal Serial Bus (USB) memory, a flash memory, and the like. The input-output I/F 100H reads an element addition program stored in the semiconductor memory 13. The input I/F 100F and the input-output I/F 100H include, for example, USB ports. The output I/F 100G includes, for example, a display port.

A portable recording medium 14 is inserted into the drive device 100I. Examples of the portable recording medium 14 include a removable disc such as a compact disc (CD)-ROM and a Digital Versatile Disc (DVD). The drive device 100I reads the element addition program recorded in the portable recording medium 14. For example, the network I/F 1000 includes a local area network (LAN) port, a communication circuit, and the like.

The CPU 100A temporarily stores the element addition program stored in at least one of the ROM 100C, HDD WOE, and the semiconductor memory 13, in the RAM 100B. The CPU 100A temporarily stores the element addition program recorded in the portable recording medium 14, in the RAM 100B. The CPU 100A implements various types of functions to be described later and executes various types of processes to be described later by executing the stored element addition program. The element addition program may be a program corresponding to a flowchart to be described later.

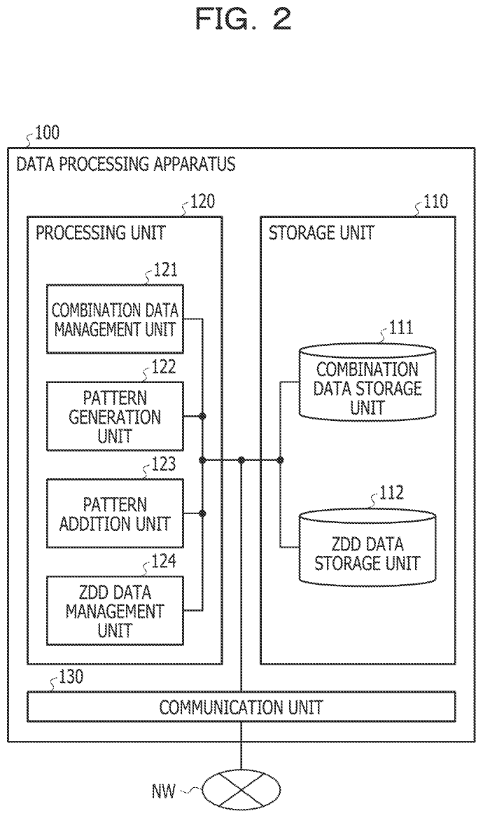

Functional configurations of the data processing apparatus 100 will be described with reference to FIG. 2. FIG. 2 illustrates a main portion of the functions of the data processing apparatus 100.

As illustrated in FIG. 2, the data processing apparatus 100 includes a storage unit 110, a processing unit 120, and a communication unit 130. The storage unit 110 may be implemented by one or both of the RAM 100B and the HDD 100E described above. The processing unit 120 may be implemented by the CPU 100A described above. The communication unit 130 may be implemented by the network I/F 100D described above. Accordingly, the storage unit 110, the processing unit 120, and the communication unit 130 are coupled to one another.

The storage unit 110 includes a combination data storage unit 111 and a ZDD data storage unit 112. The processing unit 120 includes a combination data management unit 121, a pattern generation unit 122, a pattern addition unit 123, and a ZDD data management unit 124. The combination data storage unit 111 stores a combination table. The combination table manages combination data including a subject of access and an object of access in a table format. The combination data may include contents of processes (for example, acquisition, update, and the like) to be performed on the object of access. Although details will be described later, when the communication unit 130 receives the combination data, the combination data management unit 121 acquires the combination data received by the communication unit 130, and registers a portion (for example, a portion of an element) of the acquired combination data in the combination table. The combination data storage unit 111 thereby stores the combination table including the element of the combination data. The communication unit 130 receives the combination data from another data processing apparatus (not illustrated) different from the data processing apparatus 100 via a communication network NW.

The ZDD data storage unit 112 stores ZDD data. The ZDD data is data for managing nodes in a zero-suppressed binary decision diagram (ZDD) in a table format. The ZDD data is thus referred to as a node table hereinafter. Since the node table manages the nodes in the ZDD, it is possible to reproduce the graph-format ZDD based on the node table. Details of the pattern generation unit 122, the pattern addition unit 123, and the ZDD data management unit 124 included in the processing unit 120 will be described later.

Operations of the data processing apparatus 100 will be described next.

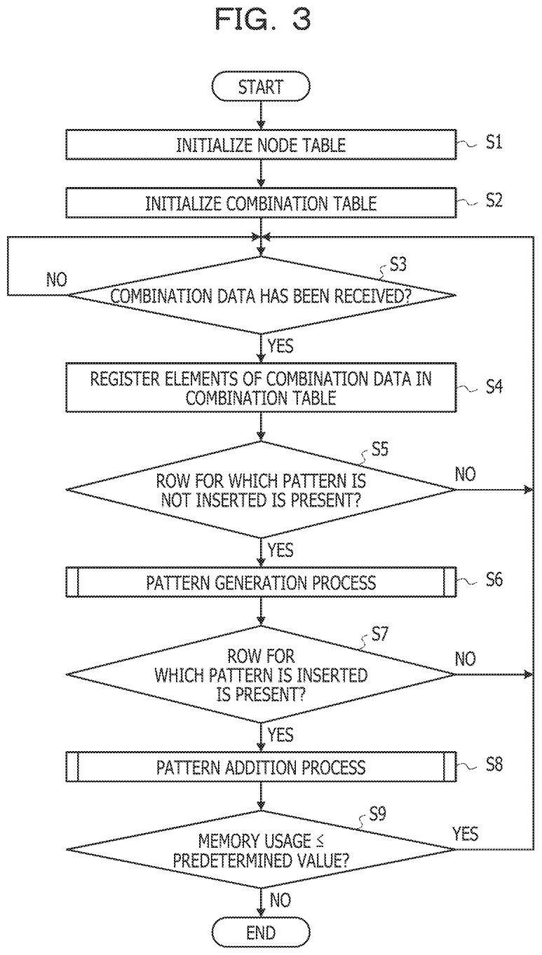

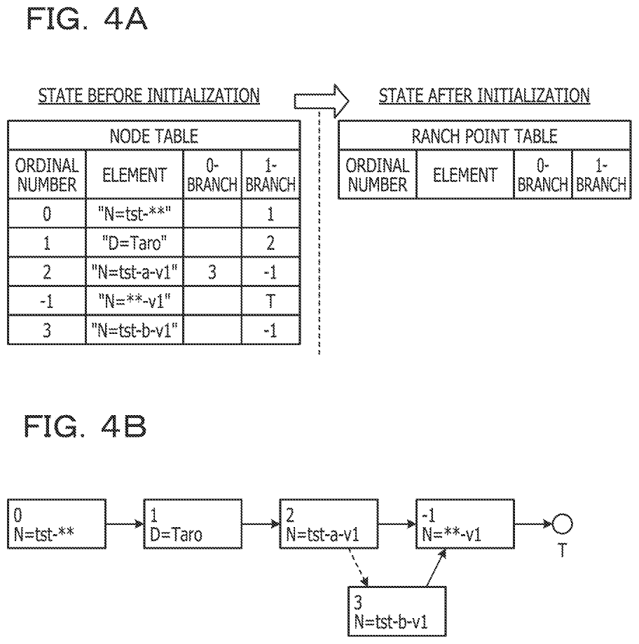

First, as illustrated in FIG. 3, the ZDD data management unit 124 initializes the node table (step S1). For example, when the ZDD data management unit 124 detects a predetermined instruction such as start of execution of the element addition program, the ZDD data management unit 124 initializes the node table. As illustrated in FIG. 4A, the node table includes a set of ordinal number and an element serving as a node, a 0-branch, and a 1-branch as properties. The node table manages one node in one row. In FIG. 4A, five nodes are managed in the node table in association with the 0-branch and the 1-branches. As illustrated in FIG. 4B, a ZDD corresponding to the node table may be expressed by using the node table. In the ZDD, nodes are expressed by rectangular figures, and the ordinal number and the element are stored in each figure.

The ordinal number expresses a numerical value corresponding to the order in which the node appears on a path of the ZDD. For example, the ordinal number “0” expresses a root of the ZDD. The element expresses a subject of access or an object of access in a format of “item=character string”. An item “D” expresses who is the subject of access, and an item “N” expresses what is the object of access. The character string expresses a specific name corresponding to the item. For example, in the case of the item “D, the character string is a specific name of a person who accesses an object such as the character string “Taro” or the character string “Hana”. In the case of the item “N”, the character string is a specific file name or data name of the accessed object, such as the character string “tst-a-v1”. The 0-branch and the 1-branch both describe the ordinal numbers of nodes that are destinations of the arrows illustrated in FIG. 4B. When terminal “T” is registered in the 1-branch, this expresses that the destination of the arrow is the terminal of the ZDD. The 1-branch is assumed to be a property of heading from a node newly added in the creation of the node table to the next node, and the 0-branch is assumed to be a property of heading from an existing node to the next node. In FIG. 4B, the broken line arrow corresponds to the 0-branch, and the solid line arrows correspond to the 1-branches.

In the ZDD, each path from the root to the terminal corresponds to one combination. Accordingly, the ZDD in FIG. 4B illustrates two paths that are a path from the ordinal number “0” to the ordinal number “1”, to the ordinal number “2”, to the ordinal number “−1.”, and to the terminal “T” and a path from the ordinal number “0” to the ordinal number “1”, to the ordinal number “2”, to the ordinal number “3”, to the ordinal number “−1”, and to the terminal “T”. In this example, two combinations are expressed by five nodes.

When the ZDD data management unit 124 initializes the node table in a state where the node table manages a plurality of nodes as illustrated on the left side of FIG. 4A, the node table is initialized and the plurality of nodes are lost as illustrated on the right side of FIG. 4A. That is, a node table having no rows of nodes is stored in the ZDD data storage unit 112.

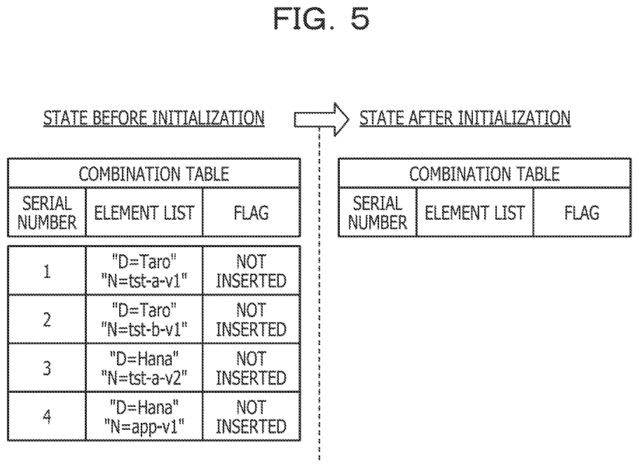

After the initialization of the node table, the combination data management unit 121 initializes the combination table (step S2). As illustrated in FIG. 5, the combination table includes a serial number, an element list, and a flag as properties. The combination table manages one piece of combination data and a processing state thereof in one row. In FIG. 5, four pieces of combination data are managed by the combination table.

The serial number is a number for identifying the combination. Every time a row is added, the combination data management unit 121 assigns a number that is not redundant, to the row. The element list is a list corresponding to the elements included in the combination data. The flag is information for identifying an insertion state of a prefix pattern and a suffix pattern to be described later in the element list. When the insertion of the prefix pattern and the suffix pattern is not completed yet, a flag “not inserted” is registered. When the insertion of the prefix pattern and the suffix pattern is completed, the combination data management unit 121 updates the flag “not inserted” to a flag “inserted”.

When the combination data management unit 121 initializes the combination table in a state where the combination table manages a plurality of pieces of combination data as illustrated on the left side of FIG. 5, the combination table is initialized and the plurality of pieces of combination data are lost as illustrated on the right side of FIG. 5. That is, a combination table that has no rows of combination data is stored in the combination data storage unit 111.

After the initialization of the combination table, the combination data management unit 121 determines whether the communication unit 130 has received combination data or not (step S3). When the communication unit 130 has received no combination data, the combination data management unit 121 determines that the communication unit 130 has received no combination data (step S3: NO). In this case, the combination data management unit 121 waits until the communication unit 130 receives combination data. When the communication unit 130 receives combination data, the combination data management unit 121 determines that the communication unit 130 has received combination data (step S3: YES). In this case, the combination data management unit 121 acquires the combination data received by the communication unit 130 and registers elements of the combination data in the combination table (step S4).

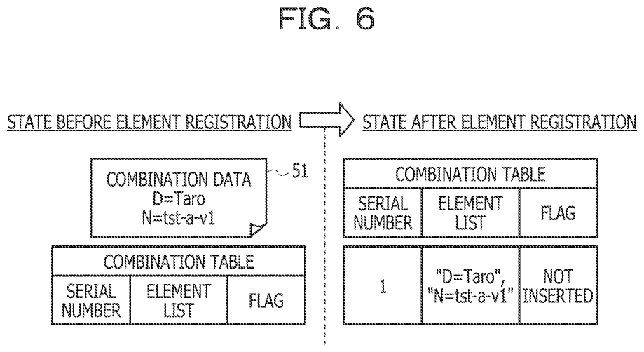

Accordingly, when the combination data management unit 121 acquires combination data 51 in a state where the combination table manages no combination data as illustrated on the left side of FIG. 6, the combination data management unit 121 registers two elements of the combination data 51 in the element list of the combination table as illustrated on the right side of FIG. 6. For example, the combination data management unit 121 registers the element “D=Taro” and the element “N=tst-a-v1” of the combination data 51 in the element list. In the adding of these two elements, the combination data management unit 121 also associates a serial number “1” and the flag “not inserted” with the two elements.

When the elements of the combination data are registered in the combination table, the pattern generation unit 122 determines whether there is a row for which a pattern is not inserted (step S5). The pattern generation unit 122 refers to the flag in the combination table, and determines whether there is a row for which a pattern is not inserted. When there is no row with the flag “not inserted”, the pattern generation unit 122 determines that there is no row for which a pattern is not inserted (step S5: NO). In this case, the process returns to a point immediately before the process of step S3.

Meanwhile, when there is a row with the flag “not inserted”, the pattern generation unit 122 determines that there is a row for which a pattern is not inserted (step S5: YES). In this case, the pattern generation unit 122 executes a pattern generation process (step S6). Although details will be described later, the pattern generation process is a process of executing operations such as generation of the prefix pattern and the suffix pattern based on the element registered in the element list of the combination table. The prefix pattern is a pattern in which a portion following a delimiter that appears first in a delimiter-containing character string included in the element is replaced with an alternative character “*” (asterisk) expressing arbitrary character. The suffix pattern is a pattern in which a portion preceding a delimiter that appears last in the delimiter-containing character string included in the element is replaced with the alternative character “*”. The alternative character is a so-called wild card. In the embodiment, an alternative character “?” or the like may be employed instead of the alternative character “*”.

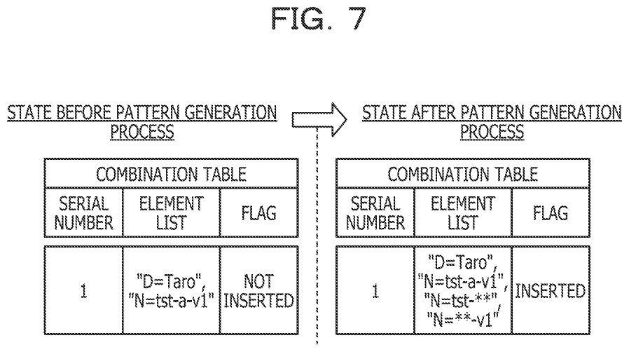

When two elements are registered in the element list of the combination table as illustrated on the left side of FIG. 7, one prefix pattern and one suffix pattern are generated for the element “N=tst-a-v1” by the pattern generation process as illustrated on the right side of FIG. 7. In the embodiment, a prefix pattern “N=tst-**” and a suffix pattern “N=**-v1” are generated. The reason why the prefix pattern and the suffix pattern are generated for the element “N=tst-a-v1” is that a delimiter “-” (hyphen) is added to the character string “tst-a-v1” in the element “N=tst-a-v1”. Since no delimiter “-” is added to the character string “Taro” of the element “D=Taro”, neither the prefix pattern nor the suffix pattern is generated for the element “D=Tare”. The generated prefix pattern and suffix pattern are inserted into the element list of the combination table.

In the present embodiment, the alternative character “*” is doubled by being successively arranged. Doubling the alternative character “*” enables matching with a matching target over the delimiter “-”. A single alternative character “*” may replace in units of partial character strings (for example, “v1” and the like) sectioned by the delimiter “-”. The alternative character “*” to be used does not have to be unified to the single alternative character or the double alternative character and both may be used in parallel. For example, the alternative character “*” may be used singularly or doubly depending on the character string.

When the execution of the pattern generation process is completed, the pattern addition unit 123 determines whether there is a row for which a pattern is inserted (step S7). For example, the pattern addition unit 123 refers to the combination table stored in the combination data storage unit 111, and determines whether there is a row for which a pattern is inserted. For example, the pattern addition unit 123 may determine whether there is a row for which a pattern is inserted by referring to the flag in the combination table and checking whether there is the flag “inserted”. When there is no row for which a pattern is inserted (step S7: NO), the process returns to the point immediately before the process of step S3.

Meanwhile, when there is a row for which a pattern is inserted (step S7: YES), the pattern addition unit 123 executes a pattern addition process (step S8). Although details will be described later, the pattern addition process is a process of simultaneously adding the element, the prefix pattern, and the suffix pattern registered in the element list of the combination table, to the node table. In the adding, in the pattern addition process, an ordinal number is assigned to each of the element, the prefix pattern, and the suffix pattern, the 1-branch and the 0-branch are updated, and the combination data for one row is deleted from the combination table. “Simultaneously” herein does not have to be precisely the same time, and may mean substantially same time, for example, in the same addition process or at the same timing.

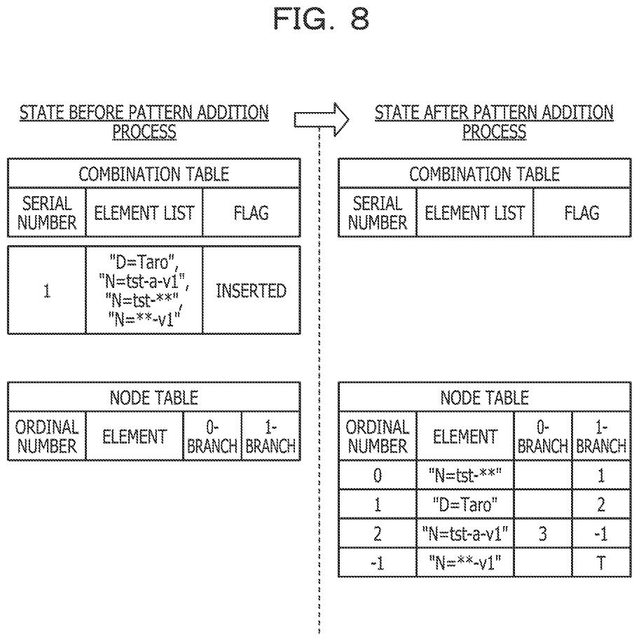

When the element, the prefix pattern, and the suffix pattern are registered in the element list of the combination table in a state where the node table manages no node as illustrated on the left side of FIG. 8, the element, the prefix pattern, and the suffix pattern registered in the element list are added to the node table by the pattern addition process as illustrated on the right side of FIG. 8. In the adding, an ordinal number is assigned to each of the element, the prefix pattern, and the suffix pattern, the 1-branch and the 0-branch are updated, and the combination data for one row is deleted from the combination table. Managing the nodes with the node table enables reproduction of the ZDD corresponding to the node table.

When the execution of the pattern addition process is completed, the pattern addition unit 123 determines whether or not a memory usage is equal to or less than a predetermined value (step S9). For example, the pattern addition unit 123 determines whether or not the memory usage of the node table stored in the ZDD data storage unit 112 is several gigabytes (GB) or less. The pattern addition unit 123 may determine whether or not the memory usage of the node table is equal to or less than several tens of percent (for example, 80 percent, 90 percent, or the like). When the memory usage is equal to or less than the predetermined value (step S9: YES), the process returns to the point immediately before step S3. When the memory usage is larger than the predetermined value (step S9: NO), the data processing apparatus 100 terminates the process.

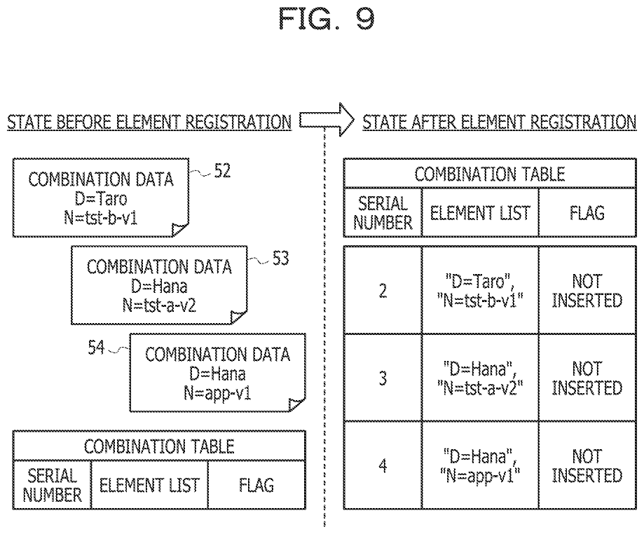

Accordingly, when the aforementioned process is completed and then the communication unit 130 receives pieces of combination data 52, 53, and 54 in a state where the combination table manages no combination data as illustrated on the left side of FIG. 9, the combination data management unit 121 newly acquires the pieces of combination data 52, 53, and 54. When the combination data management unit 121 acquires the pieces of combination data 52, 53, and 54, the combination data management unit 121 designates, for example, the combination data 52 as a processing target, and registers the element “D=Taro” and the element “N=tst-b-v1” in the combination data 52, in the element list of the combination table, as illustrated on the right side of FIG. 9. In the adding of these two elements, the combination data management unit 121 also associates the serial number “2” and the flag “not inserted” with the two elements. The combination data management unit 121 then designates the pieces of combination data 53 and 54 one by one as the processing target, and executes similar processes. As described above, the three pieces of combination data are newly managed in the combination table.

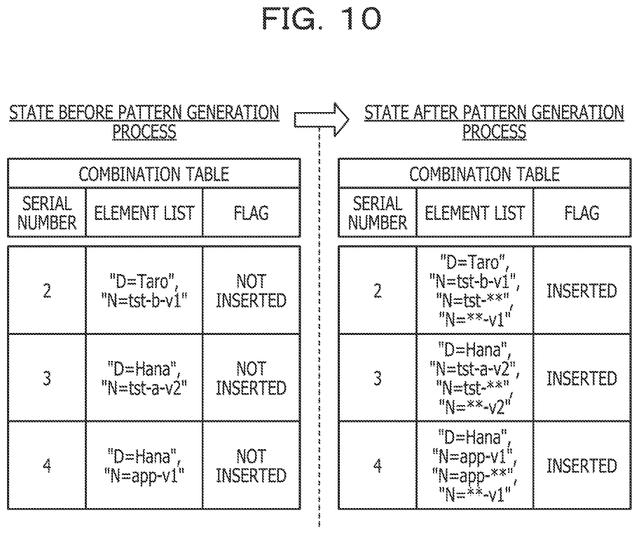

Next, as illustrated in FIG. 10, the prefix pattern and the suffix pattern are generated by the pattern generation process, for each of the elements including a character string provided with the delimiter “-” among the elements registered in the element list of the combination table. The generated prefix pattern and suffix pattern are inserted into the same element list as the element being the generation source. The combination table thus newly manages three pieces of combination data each including the elements and the newly inserted prefix pattern and suffix pattern.

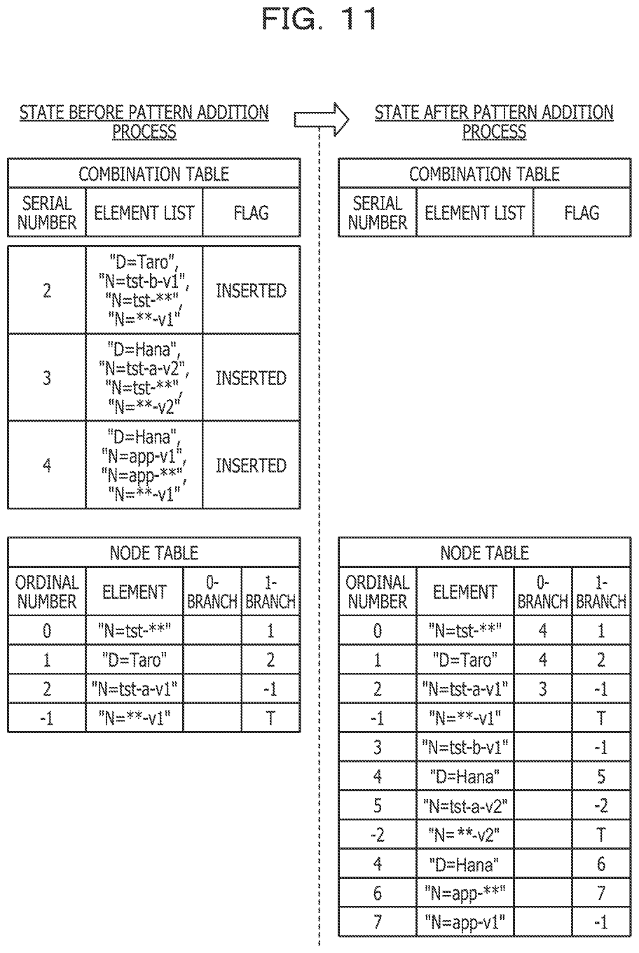

As illustrated on the left side of FIG. 11, when the combination table manages the new pieces of combination data, the elements, the prefix patterns, and the suffix patterns registered in the element list are added to the node table by the pattern addition process as illustrated on the right side of FIG. 11. When the node table already manages four nodes as illustrated on the left side of FIG. 11, seven nodes not redundant with the already-managed four nodes are newly added to the node table. In the adding, an ordinal number is newly assigned to each of the elements, the prefix patterns, and the suffix patterns, the 1-branch and the 0-branch are updated, and three rows of combination data are deleted from the combination table. The same ordinal number is assigned to the same node as for the element “D=Hana”. Newly managing the nodes with the node table enables reproduction of the ZDD corresponding to the node table.

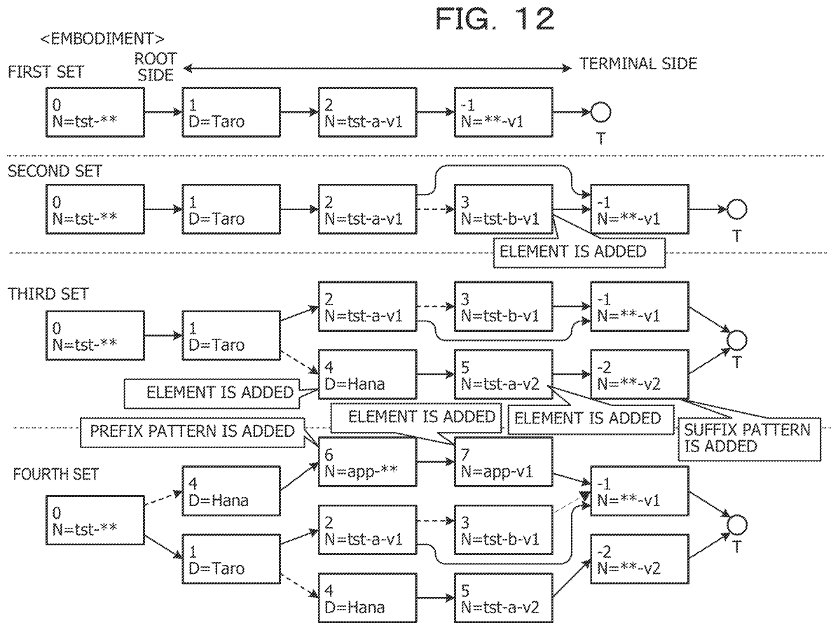

For example, the ZDD may be reproduced as illustrated in FIG. 12 by performing the processes described with reference to FIGS. 3 to 11. For example, the node table manages four nodes based on reception of the combination data 51 (see FIGS. 6 to 8). In this case, as illustrated in the first set of FIG. 12, a ZDD in which four nodes are linked by 1-branches may be reproduced based on this node table.

In the ZDD according to the embodiment, the node of the prefix pattern and the node of the suffix pattern are added while being distributed respectively to two regions on the root side and the terminal side of the ZDD. Although details will be described later, this is because positive ordinal numbers are assigned to the element and the prefix pattern, and the nodes of the element and the prefix pattern to which the positive ordinal numbers are assigned are added to the root side. Meanwhile, a negative ordinal number is assigned to the suffix pattern, and the node of the suffix pattern to which the negative ordinal number is assigned is added to the terminal side.

When the node table manages five nodes based on reception of the combination data 52 (not illustrated), the ZDD may be reproduced based on this node table as illustrated in the second set of FIG. 12. Thereafter, when the node table manages eight nodes based on reception of the combination data 53 (not illustrated), the ZDD may be reproduced based on this node table as illustrated in the third set of FIG. 12. When the node table manages 11 nodes based on reception of the combination data 54 (see FIG. 11), the ZDD may be reproduced based on this node table as illustrated in the fourth set of FIG. 12. In all cases, the node of the prefix pattern and the node of the suffix pattern are added while being distributed respectively to the two regions on the root side and the terminal side of ZDD.

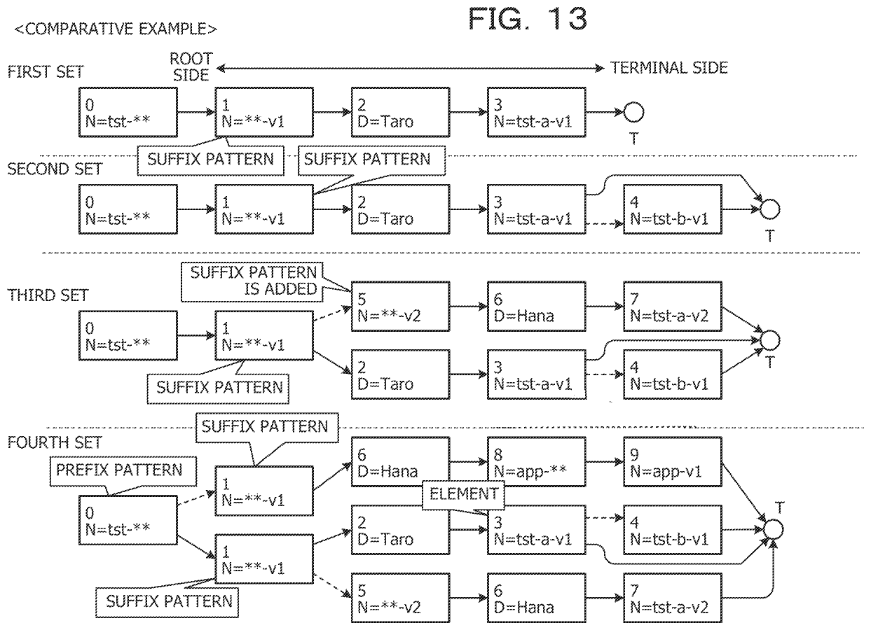

A comparative example will be described with reference to FIG. 13. As illustrated in FIG. 13, in the comparative example, a negative ordinal number is not assigned to the suffix pattern. In the comparative example, a positive ordinal number is assigned to each of the element, the prefix pattern, and the suffix pattern. As a result, for example, the node including the suffix pattern “N=**-v1” is arranged between a root node including the prefix pattern “N=tst-**” and the element “N=tst-a-v1” that is the generation source of this prefix pattern.

The numbers of combinations (the number of paths) in the ZDDs of the respective first to third sets illustrated in FIG. 13 are one, two, and three, respectively, and are the same as the numbers of combinations in the embodiment described with reference to FIG. 12. The numbers of nodes in the ZDDs of the respective first to third sets illustrated in FIG. 13 are four, five, and eight, respectively, and are the same as the numbers of nodes in the embodiment described with reference to FIG. 12. The number of combinations in the fourth set illustrated in FIG. 13 is four, and is the same as the number of combinations in the embodiment described with reference to FIG. 12, but the number of nodes is 12, and is one larger than the number of nodes 11 in the embodiment described with reference to FIG. 12. As described above, although the number of combinations is the same in the embodiment and the comparative example, the number of nodes varies. For example, in the embodiment, it is possible to reduce the number of nodes from that in the comparative example, and as a result, also reduce the memory usage.

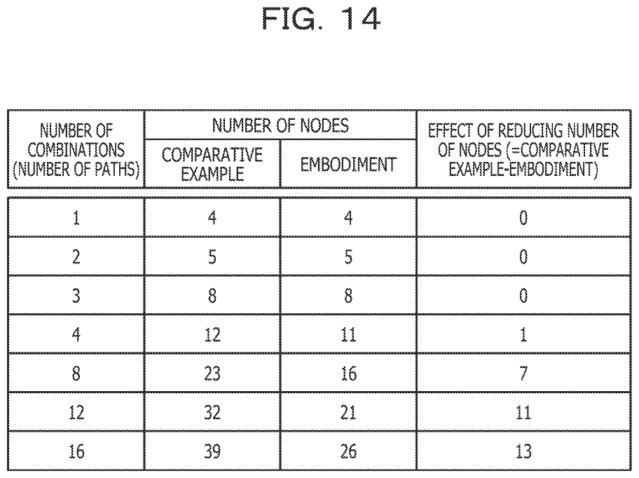

As illustrated in FIG. 14, the effect of reducing the number of nodes described above becomes more significant as the number of combinations increases. Although the case where the number of combinations is four is described in FIGS. 12 and 13, when the number of combinations is eight, the number of nodes may be reduced by seven. When the number of combinations is 12, the number of nodes may be reduced by 11. When the number of combinations is 16, the number of nodes may be reduced by 13.

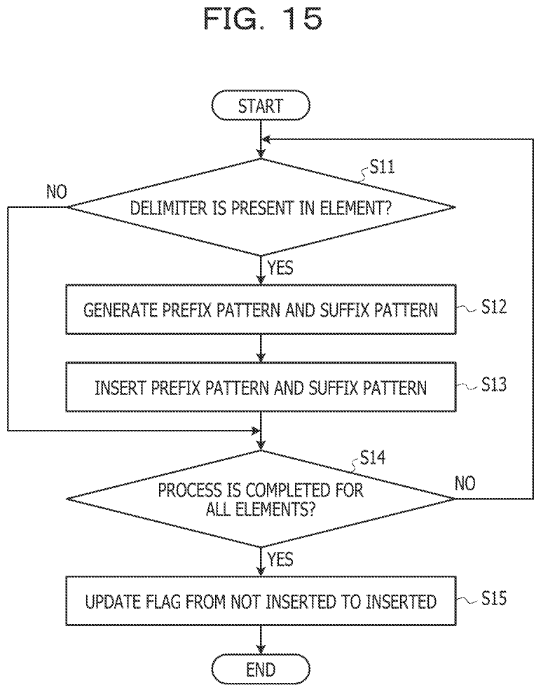

Details of the aforementioned pattern generation process will be described with reference to FIG. 15.

In the pattern generation process, first, the pattern generation unit 122 determines whether or not there is the delimiter in the element (step S11). For example, the pattern generation unit 122 accesses the combination data storage unit 111 and acquires one of the elements registered in the element list of the combination table stored in the combination data storage unit 111, from the top in the order of the registration. When the element is acquired, the pattern generation unit 122 determines whether the character string of the acquired element includes a delimiter or not, for each element.

For example, in the case of the element “D=Taro” (see FIG. 7), the character string “Taro” of this element does not include the delimiter “-”. In this case, the pattern generation unit 122 determines that the element includes no delimiter (step S11: NO), and determines whether or not the pattern generation process for all the elements is completed (step S14). In the embodiment, the pattern generation process is not completed for the element “N=tst-a-v1” (see FIG. 7). The pattern generation unit 122 thus determines that the pattern generation process is not completed for all the elements (step S14: NO), and the process returns to a point immediately before step S11.

As a result, the pattern generation unit 122 acquires the element “N=tst-a-v1” (see FIG. 7) next in the order of registration, and determines whether or not the character string of this element includes the delimiter. In the case of the element “N=tst-a-v1”, the character string “tst-a-v1” includes the delimiter “-”. In this case, the pattern generation unit 122 determines that the element includes the delimiter (step S11: YES), and generates the prefix pattern and the suffix pattern based on the element (step S12). Although the pattern generation unit 122 simultaneously generates the prefix pattern and the suffix pattern in the embodiment, the pattern generation unit 122 may generate the prefix pattern and then generate the suffix pattern or may generate these patterns in the opposite order.

When the prefix pattern and the suffix pattern are generated, the pattern generation unit 122 inserts the prefix pattern and the suffix pattern into the same element list as the element being the generation source (step S13). The prefix pattern “N=tst-**” and the suffix pattern “N=**-v1” are thereby inserted into the element list (see FIG. 7). When the prefix pattern and the suffix pattern based on the element “N=tst-a-v1” are inserted, in the embodiment, the pattern generation unit 122 determines that the pattern generation process for all the elements is completed (step S14: YES). When the pattern generation process for all the elements is completed, the pattern generation unit 122 updates the flag from “not inserted” to “inserted” (step S15), and terminates the pattern generation process. When the element list includes no element with a character string having the delimiter “-”, neither the prefix pattern nor the suffix pattern is generated and the flag is updated from “not inserted” to “inserted”.

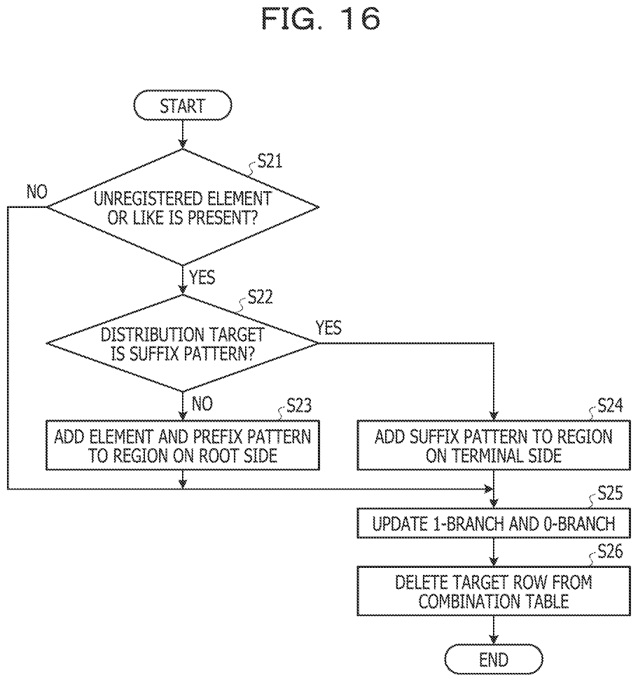

Details of the aforementioned pattern addition process will be described with reference to FIG. 16.

In the pattern addition process, first, the pattern addition unit 123 determines whether the node table includes an unregistered element or the like (step S21). For example, the pattern addition unit 123 accesses the element list (see FIG. 8) in the combination table for which the flag is updated to “inserted”, and determines whether the element list includes the element, the prefix pattern, or the suffix pattern that is not registered in the node table. In the embodiment, none of the two elements, the prefix pattern, and the suffix pattern are registered in the node table. The pattern addition unit 123 thus determines that the node table includes an unregistered element (step S21: YES).

When the pattern addition unit 123 determines that the node table includes an unregistered element, the pattern addition unit 123 then acquires the element, the prefix pattern, and the suffix pattern in the element list as distribution targets, and determines whether each distribution target is the suffix pattern or not (step S22).

For example, when the element and the prefix pattern is acquired as the distribution target, the pattern addition unit 123 determines that the distribution target is not the suffix pattern (step S22: NO). In this case, the pattern addition unit 123 adds the element and the prefix pattern being the distribution target, to the region on the root side of the ZDD (step S23). For example, when the element and the prefix pattern are present in a mixed manner, the pattern addition unit 123 prioritizes the prefix pattern over the element and assigns an ordinal number “0” to the prefix pattern as a positive ordinal number. The pattern addition unit 123 assigns ordinal numbers to elements in the ZDD in ascending order of the registration of the elements such that a positive ordinal number “1”, being the largest ordinal number in the ZDD, is assigned to the first element and then an ordinal number “2”, being further the largest ordinal number in the ZDD, is assigned to the next element (see FIG. 8 for above).

Meanwhile, when the suffix pattern is acquired as the distribution target, the pattern addition unit 123 determines that the acquired distribution target is the suffix pattern (step S22: YES). In this case, the pattern addition unit 123 adds the suffix pattern being the distribution target, to the region on the terminal side of the ZDD (step S24). For example, the pattern addition unit 123 assigns a negative ordinal number “−1”, being the smallest ordinal number in the ZDD, to the suffix pattern (see FIG. 8). If the negative ordinal number “−1” is already assigned to the suffix pattern, the pattern addition unit 123 assigns a negative ordinal number“−2”, being further the smallest ordinal number in the ZDD, to the suffix pattern. The element and the prefix pattern are thus added to the ZDD while being distributed to the region on the root side by the process of step S23. The suffix pattern is added to the ZDD while being distributed to the region on the terminal side by the process of step S24. The pattern addition unit 123 simultaneously executes the processes of steps S23 and S24.

When the node table includes no unregistered element in the process of step S21 (step S21: NO) or when the processes of steps S23 and S24 are completed, the pattern addition unit 123 updates the 1-branch and the 0-branch (step S25). For example, the pattern addition unit 123 calculates the sum of the current ZDD and a ZDD including only the combinations to be added, and updates the 1-branch and the 0-branch.

The sum of the current. ZDD and the ZDD including only the combinations to be added may be calculated by a recursive function that takes the following nodes as inputs and outputs.

<Recursive Function>

“Sum (f, g)” is the following process that outputs a node by taking a node f and a node g as inputs.
If f==g, f is outputted.
If f==empty, g is outputted.
If g==empty, f is outputted.
If f<g,
there is outputted a node that “has the same ordinal number, element, and 1-branch as f and has a 0-branch which is ‘sum(0-branch of f, g)’”.
If f>g,
there is outputted a node that “has the same ordinal number, element, and 1-branch as g and has a 0-branch which is ‘sum(f, 0-branch of g)’”.
If ordinal number of f==ordinal number of g,
there is outputted a node that “has the same ordinal number and the element as f, has a 1-branch which is ‘sum(1-branch of f, 1-branch of g)’, and has a 0-branch which is ‘sum(0-branch of f, 0-branch of g)’”.

In this disclosure, magnitude comparison capable of handling negative ordinal numbers is further performed for the aforementioned cases of f<g and f>g as follows.

“f<g”
does not hold if f==g or f==T (terminal).
If f and g both have “positive ordinal numbers” or “negative ordinal numbers”,
“f<g” holds, provided that ordinal number of f<ordinal number of g.
If only f has a “negative ordinal number”, “f<g” does not hold.
If only g has a “negative ordinal number”, “f<g” holds.
“f>g”
does not hold if f==g or g==T (terminal).
If f and g both have “positive ordinal numbers” or “negative ordinal numbers”,
“f>g” holds, provided that ordinal number of f>ordinal number of g.
If only f has a “negative ordinal number”, “f>g” holds.
If only g has a “negative ordinal number”, “f>g” does not hold.

The 1-branch is updated, for example, when the sum of the current ZDD and a ZDD corresponding to the node table in the state after the pattern addition process illustrated on the right side of FIG. 8 is calculated by the aforementioned recursive function, with the current ZDD being a ZDD corresponding to the node table in the state before the pattern addition process illustrated on the left side of FIG. 8. For example, as illustrated on the right side of FIG. 8, a 1-branch “1” is registered for the node with the ordinal number “0”. A 1-branch “2” is registered for the node with the ordinal number “1”. A 1-branch “−1” is registered for the node with the ordinal number “2”. A 1-branch “T” is registered for the node with the ordinal number “−1”. For example, the nodes are coupled in the order of the root, the positive ordinal numbers, the negative ordinal numbers, and the terminal. The positive ordinal numbers are added in ascending order. This node table corresponds to the ZDD of the first set in FIG. 12.

The 1-branch and the 0-branch are similarly updated, for example, when the sum of the current ZDD and a ZDD corresponding to the node table in the state after the pattern addition process illustrated on the right side of FIG. 11 is calculated by the aforementioned recursive function with the current ZDD being a ZDD corresponding to the node table in the state before the patter addition process illustrated on the left side of FIG. 11. For example, as illustrated on the right side of FIG. 11, a 0-branch “4” is registered for the node with the ordinal number “0”. The 0-branch “4” is registered for the node with the ordinal number “1”. A 0-branch “3” is registered for the node with the ordinal number “2”. Although details are omitted, the ordinal numbers of coupling destinations are also registered in the 1-branches in a similar manner for the nodes with remaining positive ordinal numbers including the ordinal number “3” and the node with the ordinal number “−2”. This node table corresponds to the ZDD of the fourth set in FIG. 12.

As described above, in linking between nodes with positive ordinal numbers and between nodes with negative ordinal numbers, the nodes are linked to each other by directing a branch in a direction from the node with the smaller ordinal number to the node with the larger ordinal number. Meanwhile, in linking between a node with a positive ordinal number and a node with a negative ordinal number, the nodes are linked to each other by directing a branch in a direction from the node with the positive ordinal number to the node with the negative ordinal number. Arranging the suffix pattern from the terminal “T” side may avoid the case where the suffix pattern is arranged between the element and the prefix pattern based on this element. As a result, it is possible to suppress excessive emergence of nodes and suppress an increase in the number of nodes.

After the process of step S25 is completed, the pattern addition unit 123 deletes the target row from the combination table (step S26), and terminates the pattern addition process. As illustrated in, for example, FIGS. 8 and 11, the row of the combination data is thereby lost from the combination table.

Although the preferred embodiment of the present disclosure has been described in detail above, the present disclosure is not limited to the specific embodiment according to the present disclosure, and various modifications and changes may be made within the gist of the present disclosure described in the claims.

For example, although description is given by using the ZDD as an example of the binary decision diagram in the aforementioned embodiment, a binary decision diagram (BDD) may be used instead of the ZDD. Although description is given by using the delimiter “-” in the above embodiment, the delimiter may be a delimiter “,” (comma), a delimiter “:” (colon), a delimiter “ ” (space), or the like as long as the delimiter is a character that has an effect of separating words from each other. Although the node of the element and the node of the prefix pattern are added to the region on the root side and the suffix pattern is added to the region on the terminal side, the addition may be performed by a similar method such that the node of the element and the node of the prefix pattern are added to the region on the terminal side and the suffix pattern is added to the region on the root side.

Although the positive and negative ordinal numbers are used in the aforementioned embodiment, characters such as alphabets may be used in ascending order and descending order, instead of the positive and negative ordinal numbers. For example, the configuration may be such that the root is expressed by the character “N”, the characters “P” and beyond are assigned to the element and the prefix pattern in ascending order, and the characters “M” and beyond are assigned to the suffix pattern in descending order. However, using the positive and negative ordinal numbers has such an advantage that, for example, the magnitudes of the ordinal numbers may be compared without reduction in processing speed of conversion from ordinal numbers to memory addresses, and has other similar advantages in terms of implementing the present disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an element addition program that causes a computer to execute a process, the process comprising:
generating a prefix pattern and a suffix pattern based on an element that is added to a binary decision diagram, in response to registration of the element; and
adding the prefix pattern and the suffix pattern to the binary decision diagram while distributing the prefix pattern and the suffix pattern respectively to two regions on a root side and a terminal side of the binary decision diagram.

2. The non-transitory computer-readable recording medium according to claim 1, the process further comprising:
adding the prefix pattern to the binary decision diagram while distributing the prefix pattern to the region on the root side by assigning a positive first ordinal number to the prefix pattern, the first ordinal number determining an order of the prefix pattern in the binary decision diagram; and
adding the suffix pattern to the binary decision diagram while distributing the suffix pattern to the region on the terminal side by assigning a negative second ordinal number to the suffix pattern, the second ordinal number determining an order of the suffix pattern in the binary decision diagram.

3. The non-transitory computer-readable recording medium according to claim 2, the process further comprising:
linking the prefix pattern to which the first ordinal number is assigned and the suffix pattern to which the second ordinal number is assigned to each other by directing a branch in the binary decision diagram from the prefix pattern to which the first ordinal number is assigned to the suffix pattern to which the second ordinal number is assigned.

4. The non-transitory computer-readable recording medium according to claim 1, the process further comprising:
generating the prefix pattern by replacing a tail portion of a character string included in the element with an alternative character expressing arbitrary character; and
generating the suffix pattern by replacing a head portion of the character string with the alternative character.

5. The non-transitory computer-readable recording medium according to claim 1, the process further comprising:
adding the prefix pattern and the suffix pattern substantially at a same time while being distributed respectively to the two regions.

6. The non-transitory computer-readable recording medium according to claim 1, the process further comprising:
generating the prefix pattern as a first element;
generating the suffix pattern as a second element;
adding the first element while distributing the first element to the region on the root side; and
adding the second element while distributing the second element to the region on the terminal side.

7. The non-transitory computer-readable recording medium according to claim 1, wherein the binary decision diagram is a zero-suppressed binary decision diagram.

8. An element addition method, comprising:
generating, by a computer, a prefix pattern and a suffix pattern based on an element that is added to a binary decision diagram, in response to registration of the element; and
adding the prefix pattern and the suffix pattern to the binary decision diagram while distributing the prefix pattern and the suffix pattern respectively to two regions on a root side and a terminal side of the binary decision diagram.

9. An information processing apparatus, comprising:
a memory; and
a processor coupled to the memory and the processor configured to:
generate a prefix pattern and a suffix pattern based on an element that is added to a binary decision diagram, in response to registration of the element; and
add the prefix pattern and the suffix pattern to the binary decision diagram while distributing the prefix pattern and the suffix pattern respectively to two regions on a root side and a terminal side of the binary decision diagram.
